(19) United States
(12) Patent Application Publication
(10) Pub. No.: US 2026/0116444 A1
(43) Pub. Date: Apr. 30, 2026

(54) MODULAR CART ASSEMBLY

(71) Applicant: Sani-Matic, Inc., Sun Prairie, WI (US)

(72) Inventor: Michael Jeffrey Borkowski, McFarland, WI (US)

(21) Appl. No.: 19/368,603

(22) Filed: Oct. 24, 2025

Related U.S. Application Data
(60) Provisional application No. 63/711,258, filed on Oct. 24, 2024.

(51) Int. Cl. B62B 3/00; A47L 15/00; B62B 3/02; B62B 5/04

(52) U.S. Cl. CPC B62B 3/006; A47L 15/0076; B62B 3/02; B62B 5/0457

(57) ABSTRACT

A modular cart assembly has a base with two support columns extending upward from the base, a plurality of slots and a plurality of mounting openings positioned along the two support columns, and at least one removable part module. The removable part module has a plurality of hooks configured to removably mate with the plurality of slots, and a plurality of mounting members configured to be removably received in the plurality of mounting holes. The removable part module is configured to accommodate a plurality of items to be cleaned.

### FIELD OF THE INVENTION

The present technology relates to washing systems for food industry. In particular, the present technology relates to a modular cart assembly for holding the parts to be cleaned.

### BACKGROUND OF THE INVENTION

There are known washing systems for food industry that wash food remnants and other substances adhered to parts or items to be cleaned by using a detergent and wash water. The known washing systems are typically provided with preassembled non-removable racks for placing parts/items thereon inside a washing cabinet, the racks being vertically moved in a backward and forward direction to be inserted into and drawn out from the washing cabinet.

Conventional washing systems have a number of disadvantages. Primarily, the known systems utilize pre-assembled racks designed to fit particular types of items to be cleaned. The prior art designs are typically welded and cannot quickly change their structure to accommodate loading different types of parts. This does not allow a customer to easily customize the racks to fit different items, as desired. Most industries are always growing or changing to meet new demands and require flexibility of washing systems to allow customers to quickly adapt to these changes for a relatively low cost. Additionally, the parts/items to be cleaned have to be loaded into racks inside a washer before the cleaning cycle begins and have to be unloaded and taken out of the washer one by one after the cleaning is completed. This takes time and effort to accomplish, which is disadvantageous, especially in a context of a commercial food establishment or an industrial food packaging facility, where the part/items have to be cleaned quicker and more efficiently.

What is desired, therefore, is a modular cart that can be easily customized to accommodate loading different types of parts to be washed.

What is also desired is an automated washing system for cleaning parts/items that is more efficient and allows for items to be loaded and unloaded quicker.

### SUMMARY OF THE INVENTION

In order to overcome the deficiencies of the prior art and to achieve at least some of the objects and advantages listed, the invention comprises, in an exemplary embodiment, a modular cart assembly including a base with two support columns extending upward from the base, a plurality of slots and a plurality of mounting openings positioned along the two support columns, and at least one removable part module. The removable part module includes a plurality of hooks configured to removably mate with the plurality of slots, and a plurality of mounting members configured to be removably received in the plurality of mounting openings. The removable part module is configured to accommodate a plurality of items to be cleaned.

In certain embodiments, the modular cart assembly further includes a bottom wheel portion configured to be moved on a surface, wherein the bottom wheel portion and the base portion are spaced apart. In some of these embodiments, the bottom wheel portion includes a locking mechanism configured to lock the modular cart assembly in place.

In some embodiments, each of the two support columns includes two or more vertical rails, wherein each of the vertical rails accommodates at least one of the plurality of slots and the plurality of mounting holes.

In certain embodiments, the two support columns further include one or more holding members configured to accommodate additional items to be cleaned.

In some embodiments, the at least one removable part module has a plurality of positioning elements configured to accommodate the plurality of items to be cleaned.

In certain embodiments, the at least one removable part module includes at least two side flanges extending perpendicular to a longitudinal axis of the removable part module. In some of these embodiments, one end of each side flange supports one of the plurality of hooks and the opposite end of each side flange supports one of the plurality of mounting members.

In some cases, at least one of the plurality of mounting members includes a securing device configured to removably secure the at least one removable part module in the modular cart assembly.

In another embodiment, a modular cart assembly includes a base with a plurality of slots and a plurality of mounting openings, at least one removable part module with a plurality of hooks configured to removably mate with the plurality of slots, and a plurality of mounting members configured to be removably received in the plurality of mounting openings, and a bottom wheel portion configured to be moved on a surface, wherein the bottom wheel portion and the base portion are spaced apart. The at least one removable part module is configured to accommodate a plurality of items to be cleaned.

A washer system for cleaning items is also provided, including a wash chamber with a spray bar and a door, and a modular cart assembly configured to accommodate a plurality of items to be cleaned. The modular cart assembly includes a base with a plurality of slots and a plurality of mounting openings, at least one removable part module with a plurality of hooks configured to removably mate with the plurality of slots, and a plurality of mounting members configured to be removably received in the plurality of mounting openings, and a bottom wheel portion configured to be moved on a surface, wherein the bottom wheel portion and the base portion are spaced apart. The modular cart assembly is configured to be inserted into the wash chamber through the door and is configured to remain in the wash chamber during a wash cycle.

Further objects, aspects, features, and embodiments of the present technology will be apparent from the drawing Figures and below description.

### BRIEF DESCRIPTION OF THE DRAWINGS

FIGS. 1A and 1B show general views of a modular cart assembly and a washer system according to an exemplary embodiment of the technology.

FIG. 2 shows a general view of the modular cart assembly, with an enlarged view of a portion of the cart, according to an exemplary embodiment of the technology.

FIG. 3 shows a general view of an exemplary part module for the modular cart assembly of FIG. 2.

FIG. 4 shows a schematic view of a portion of the modular cart assembly of FIG. 2, with the part module being inserted into the cart.

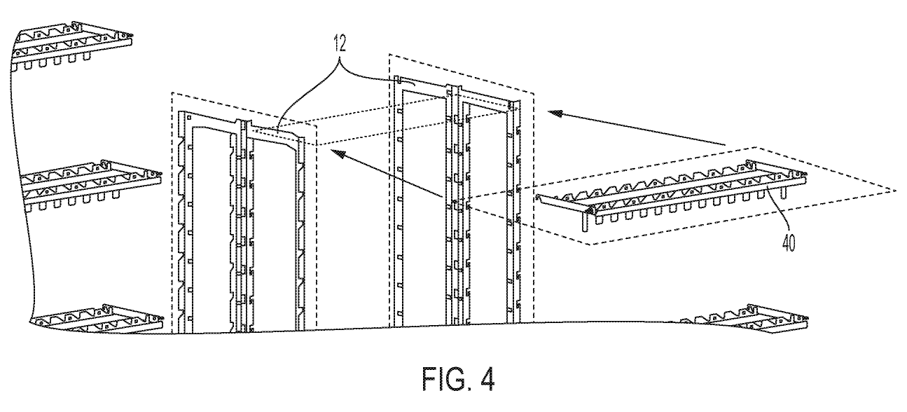

FIGS. 5A and 5B show enlarged views of a portion of the modular cart assembly with a mounting assembly.

FIG. 6A shows a general view of the modular cart assembly of FIG. 2 without the items to be cleaned. FIG. 6B shows a general view of the modular cart assembly of FIG. 6A with the items to be cleaned.

FIG. 7 shows various exemplary embodiments of the modular cart assembly according to the present technology, showing various part modules installed.

FIG. 8 shows various exemplary embodiments of part modules according to the present technology.

### DETAILED DESCRIPTION OF THE INVENTION

The following definitions and methods are provided to better define the present disclosure and to guide those of ordinary skill in the art in the practice of the present disclosure. Unless otherwise noted, terms are to be understood according to conventional usage by those of ordinary skill in the relevant art.

As used in the description, the terms "top," "bottom," "above," "below," "over," "under," "above," "beneath," "on top," "underneath," "up," "down," "upper," "lower," "front," "rear," "back," "forward" and "backward" refer to the objects referenced when in the orientation illustrated in the drawings, which orientation is not necessary for achieving the objects of the invention.

The term "about" or ''approximately" when immediately preceding a numerical value means a range (e.g., plus or minus 10% of that value). For example, "about 50" can mean 45 to 55, "about 25,000" can mean 22,500 to 27,500, etc., unless the context of the disclosure indicates otherwise, or is inconsistent with such an interpretation. For example, in a list of numerical values such as "about 49, about 50, about 55, ... '', "about 50" means a range extending to less than half the interval(s) between the preceding and subsequent values, e.g., more than 49.5 to less than 52.5. Furthermore, the phrases "less than about" a value or "greater than about" a value should be understood in view of the definition of the term “about” provided herein. Similarly, the term “about” when preceding a series of numerical values or a range of values (e.g., “about 10, 20, 30” or “about 10-30”) refers, respectively to all values in the series, or the endpoints of the range.

As used herein, the singular forms ”a,” “an,” and “the” include plural referents unless the content clearly dictates otherwise.

The term “comprising” is synonymous with “including,” “having,” “containing,” or “characterized by.” These terms are inclusive and open-ended and do not exclude additional, unrecited elements or method steps.

The present technology relates to a modular cart assembly for use with a washing system, for example a parts washer. Unlike washers where parts or items are loaded into the machine, the door is closed, and a start button is pressed to initiate a cleaning cycle, some embodiments of the present technology include a removable modular cart assembly that can be wheeled away, allowing for it to be loaded/unloaded while another cart is running through a cleaning cycle, which advantageously makes the washing/cleaning process quicker and more efficient.

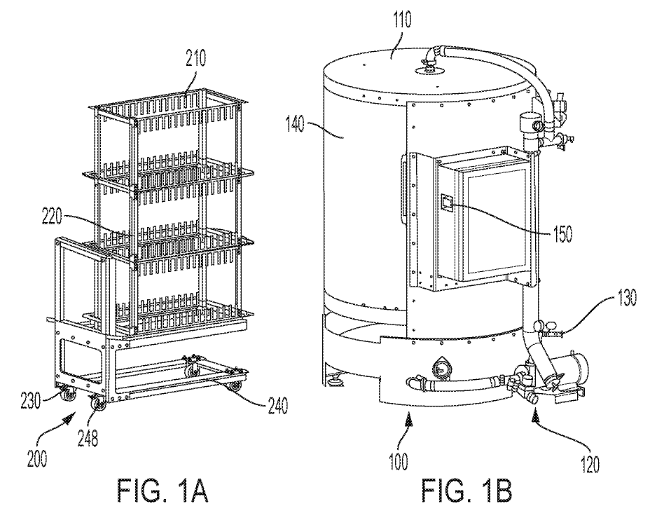

FIG. 1A shows an exemplary embodiment of the modular cart assembly 200 in accordance with the present technology. In some exemplary embodiments, the modular cart assembly is a cart system that may be shaped like a shopping cart. Dirty parts/items are loaded onto loading racks 210 and wheeled into the cabinet washer 100, as shown in FIG. 1B, which cleans the dirty parts/items that were loaded onto the cart assembly 200. It is understood that other shapes/structures and dimensions of the modular cart assembly are envisioned within the scope of the invention.

One exemplary embodiment of a cabinet washer is shown in FIG. 1B. The cabinet washer 100 may comprise several parts. There is a wash cylinder 110 which contains water for continuous recirculation of water during a wash cycle. The water capacity of the wash cylinder 110 may depend on the desired size and capacity of the washer system. The wash cylinder 110 may also contain one or more internal cleaning products or sprays that facilitate cleaning of the items/parts. The water is continuously circulated in the washer system 100 through external plumbing coupled to the wash cylinder 110. The external plumbing is coupled to an inlet port 130 of the wash cylinder for supplying fresh water to the wash cylinder and to an outlet port 120 of the wash cylinder for discarding the dirty water from the wash cycle. The cabinet washer 100 further comprises an access door 140, which, when opened, allows the modular cart assembly 200 to be positioned inside the wash cylinder 110. When closed, the access door 140 acts as a locking mechanism, preventing the sanitation cart from being removed from the wash cylinder while the washer system is running. Any suitable locking mechanism known in the art may be used to keep the door closed during the wash cycle. It is understood that the modular cart assembly 200 may be used with any other suitable washing system, in addition to that illustrated in FIG. 1B.

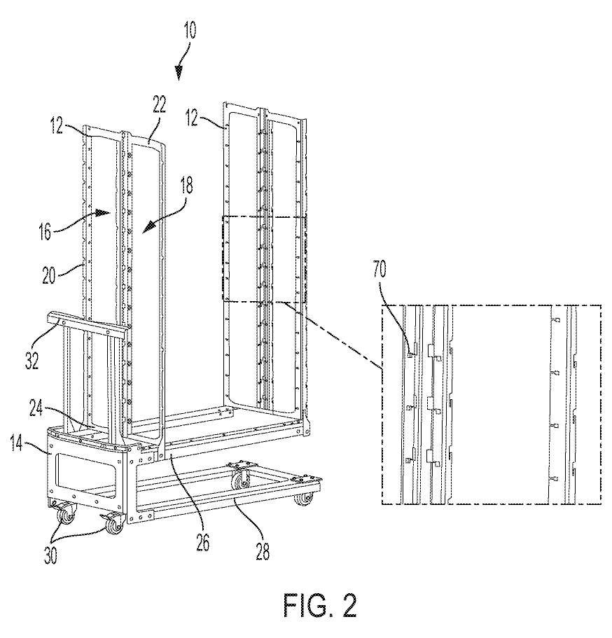

As shown in FIG. 2, the modular cart assembly 10 comprises several parts. The dimensions shown in this figure are exemplary only and other embodiments may have other dimensions. The modular cart assembly includes a rack section configured to house/support a plurality of parts/items to be cleaned. The rack section includes a base section 14 and at least two support columns 12 extending upward from the base section. In the exemplary embodiment shown in FIG. 2, each of the two support columns 12 includes a left section 16 and a right section 18 joined together. Each section has two vertical rails 20 at the perimeter joined by a top rail 22 and a bottom rail 24. It is understood that other designs for support columns may be used in accordance with the present technology. The rack section may be made with any suitable material, such as steel, aluminum, etc.

Each of the vertical rails 20 includes a plurality of slots 13 and a plurality of mounting holes 11, as shown in the partial enlarged view of FIG. 2. The plurality of slots 13 and mounting holes 11 are configured to connect and hold one or more part modules described below. The slots and mounting holes are positioned spaced apart along the vertical rails 20 of the support columns. The rows of slots and the rows of mounting holes on the support columns 12 are positioned opposite each other. Each of the support columns 12 may have one or more vertical rows of slots 13 and one or more vertical rows of mounting holes 11. In the exemplary embodiment of FIG. 2, the adjoining/adjacent vertical rails of each of the left section 16 and right section 18 of the support columns 12 each has a row of slots, and the peripheral vertical rails of each of the left section 16 and right section 18 of the support columns 12 each has a row of mounting holes. Such design allows each of the right section and left section of the support columns to accommodate a plurality of part modules. In other embodiments, only one of the rights section and left section may include the row of slots, while the other section includes the row of mounting holes. The exact positioning, pattern and spacing between each of the slots and/or mounting holes may be adjusted as necessary to accommodate different types of part modules, as discussed in more detail below.

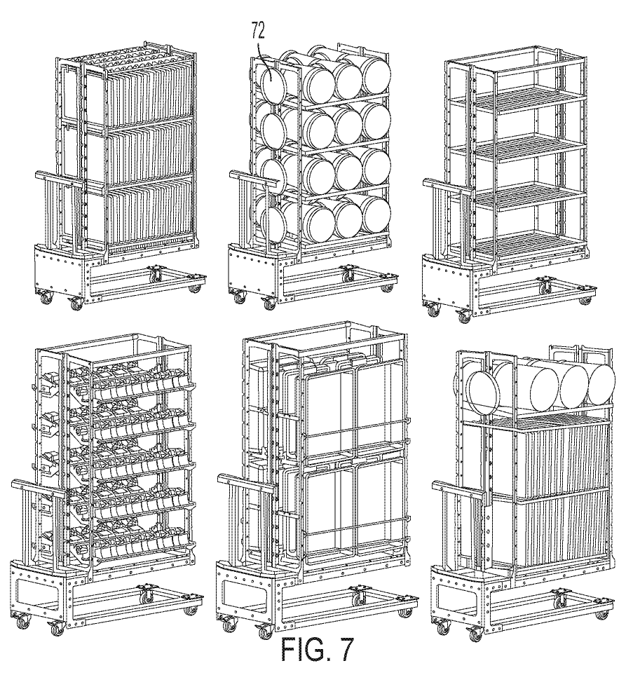

In some exemplary embodiments, such as shown in FIGS. 2 and 7, one or more vertical rails 20 may include a plurality of protrusions 70 positioned thereon. The protrusions may be positioned on a side of the rails opposite the side facing the parts module inserted in the cart. The protrusions are configured to accommodate additional items to be cleaned, such as lids 72, etc. to allow more items to be cleaned in the same washing cycle to maximize the efficiency of the washing system. The protrusions or other types of holding members may be designed to accommodate particular items, as desired. It is also envisioned that these additional holding members may be removable and may be replaced with different kinds of holding members to provide even more user customization. The holding members may be configured to be attached to the vertical rails 20 via the same hook/slot and/or mounting hole/mounting member configuration or another suitable configuration.

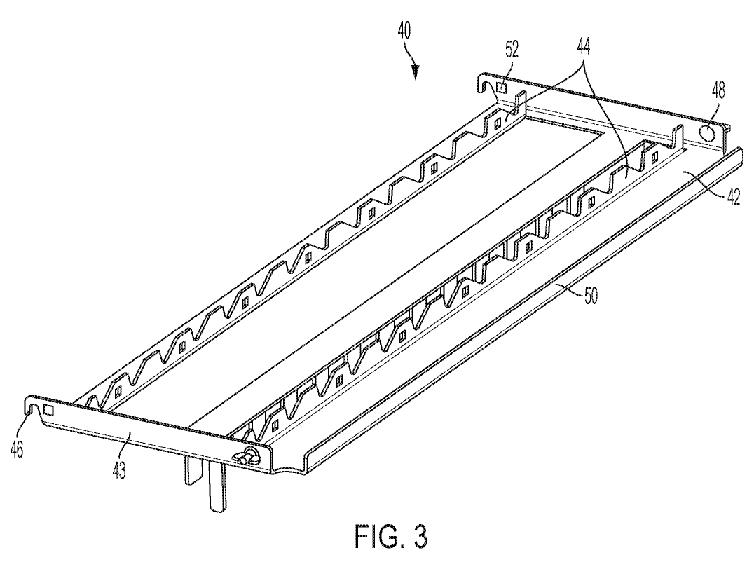

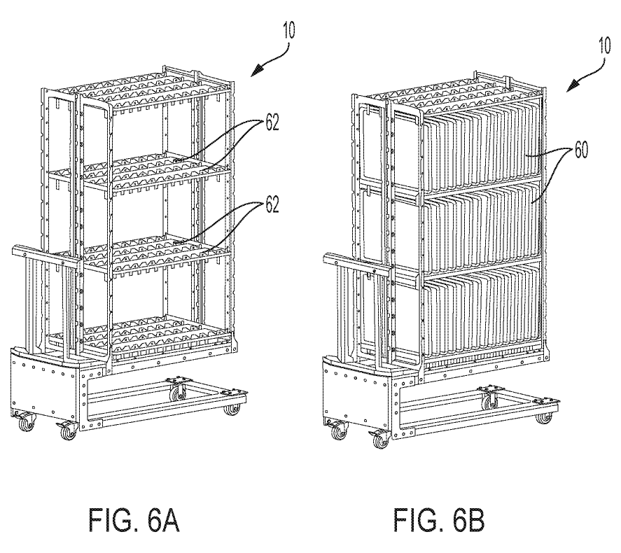

The modular cart assembly 10 further includes a plurality of part modules. One exemplary embodiment of the part module 40 is illustrated in FIG. 3. The part module includes a frame 42 sized and shaped such that it fits between the support columns 12. The part module 40 includes two rows of positioning elements 44 extending parallel to a longitudinal axis of the part module. The positioning elements 44 are configured to accommodate one or more items to be cleaned – for example, one or more serving trays, as shown in FIG. 6B. The part module 20 further includes two side flanges 43 extending perpendicular to the longitudinal axis of the part module. Each of the side flanges 43 connects to one end of the two rows of positioning elements and has a side wall extending upward from the frame 42.

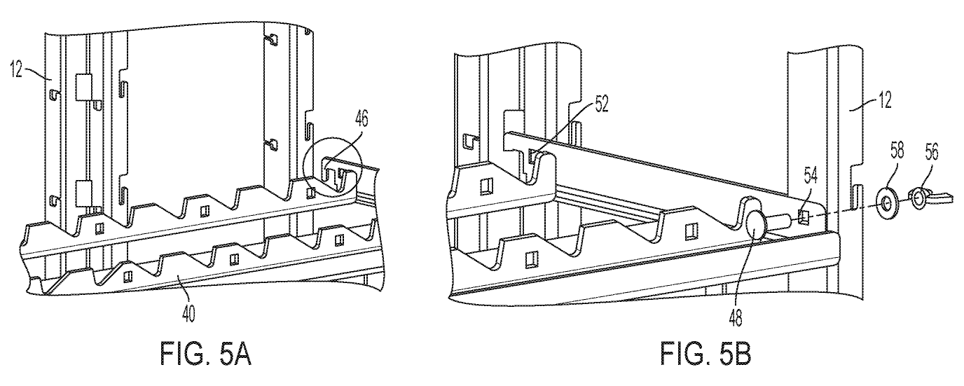

Each of the side flanges has a hook 46 positioned adjacent one end of the side flange and mounting member 48 positioned adjacent the opposite end of the side flange, as shown in FIG. 3. The hook 46 is shaped to mate with one of the slots in the support members 12 such that the part module 40 is supported on the support column 12, as shown in FIGS. 5A-5B. The hook is used to properly orient and position the part module within the support columns. In some embodiments, the hook 46 has a shape that allows the hook to securely rest within the slot to ensure that the part module is not disengaged from the sanitation cart during the cleaning process. In additional embodiments, the hooks and/or slots may be shaped such that only a particular type of hook can mate with a particular type of slot. Such design ensures that only correct part modules are installed in correct slots.

The mounting member 48 is configured to be received in one of the mounting holes on the support columns 12. The mounting member may be any suitable securing device, such as a screw or carriage bolt with a nut or winged nut, etc. Initially, the mounting member 48 is inserted into a mounting hole in the part module 40 and secured therein. When the part module is in use, as shown in FIGS. 5A-5B, the mounting member 48 is removed from the part module and the part module 40 is inserted into the cart 10 between the support columns 12. The mounting hole 54 in the part module 40 is aligned with the mounting hole on the support column 12 and the mounting member 48 (screw) is inserted through both holes and secured via a nut 56 to attach the part module 40 to the cart 12. In some embodiments, such as shown in FIG. 5B, a washer 58 may be provided between the support column 12 and the nut 56 to reduce friction, absorb vibration and prevent loosening of the nut from the screw during the washing process. The mounting member allows a user to quickly secure the part module to the support columns of the modular cart assembly without tools.

In some embodiments, as shown in FIG. 5B, the side flanges 43 may include a second mounting hole 52 that aligns with a second mounting hole on the support columns 12. An additional mounting member may be provided to further secure the part module to the support columns via the second mounting holes. Different part modules may require a plurality of hooks and/or mounting holes and mounting members to properly position and secure the part module on the modular cart assembly.

In the embodiment of FIG. 3, each part module 40 has a set of opposing hooks 46 and a set of mounting members 48 and/or 52. Other configurations are also envisioned where more than two hooks and/or more than two mounting members may be provided, as desired, to accommodate various types of part modules and/or to provide additional support and ensure secure fit of the part modules on the modular cart assembly.

The part module 40 preferably has one or more slots in the frame to allow water to drain through the module during the washing process such that water does not accumulate in the module and the items positioned therein. This also ensures efficient washing process by allowing water to reach the items positioned in the part module from different directions through the slots. The part module 40 may also include a front ledge 50 positioned on the side of the module that will face outward when in the cart. The front ledge 50 is used to pull the part module in and out of the sanitation cart.

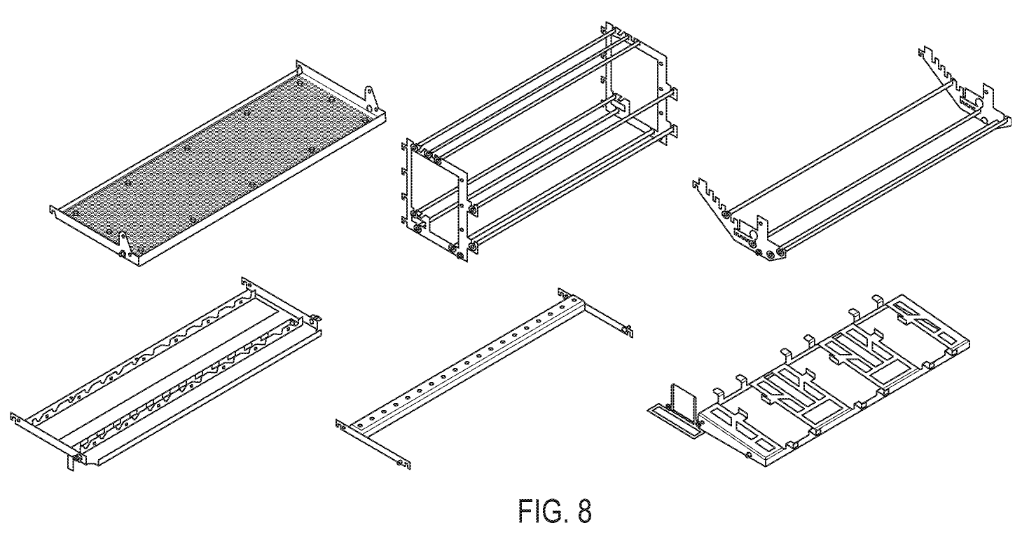

Part modules can take many different forms to hold their respective parts. FIG. 8 illustrates various embodiments of part modules designed to accommodate various types of items to be cleaned, such as trays, totes and lids, buckets and lids, miscellaneous process parts (clamps, fittings, etc.), flatware, dinnerware, crates, etc. It is understood that other part module designs not shown are envisioned within the scope of the technology. Different part modules will vary in size, shape and design, but generally include the same mounting parts – one or more hooks and one or more mounting members/mounting holes.

The modular cart assembly 10 is configured to accommodate a plurality of part modules positioned between the support columns 12. Same or different types of part modules may be inserted into the cart at the same time. It is understood that any number of rows of racks may be included in the rack system depending on the desired application. The modular cart assembly of the present technology is provided with a variety of different part modules to hold different parts to be cleaned and part modules can be easily moved to other locations to allow for different configurations. Various exemplary embodiments of the modular cart assembly with part modules installed are shown in FIG. 7.

To install a part module into the modular cart assembly 10, a user chooses a desired slot on the support columns 12 and inserts the part module hook 46 into the chosen slot. Then, the user uses the mounting member 48, 56, 58 to fasten the part module to the support column. When installed in the correct slots, the part modules hold specific parts in specific locations to be cleaned inside the washing system. FIG. 6B shows the modular cart assembly 10 with eight baking or serving tray part modules 62 installed and the same configuration with parts (trays) 60 held in place for cleaning.

Referring back to FIG. 2, the base section 14 of the modular cart assembly may include a top section 26 and a bottom section 28. The top section 26 supports the two support columns 12 secured thereto in a spaced apart manner – e.g., first support column is positioned towards a front portion of the cart and the second support column is positioned towards the rear portion of the cart at a distance from the first support column, as shown in FIG. 2. The bottom section 28 may include a plurality of wheels 30 that allow the cart to be moved on a surface. The wheels may include a locking mechanism to allow the cart to be locked in place once it is positioned inside the washer system. Any suitable lock mechanism, such as a mechanical lock, known in the art may be used. The modular cart assembly may also include a handle member 32 positioned at the rear end of the cart to facilitate transport of the cart in and out of the washer system by the user.

The top and bottom sections are spaced apart, as shown in FIG. 2. This allows the bottom part to be positioned in a frame of the washer system, while the support columns with the part modules are positioned in the wash cylinder of the washer system. For example, a cutout may be provided in a bottom portion of the wash cylinder such that the bottom section 28 of the sanitation cart may be pushed under the wash cylinder while allowing the top section 26 to be overhung inside the wash cylinder. In some embodiments, the bottom section 28 of the modular cart assembly may include tapered sliding pads (not shown) made with plastic or any other suitable material. The sliding pads facilitate alignment of the modular cart assembly with the wash cylinder via a cart alignment channel. As the modular cart assembly 10 is pushed into the cutout and the channel located at the bottom of the wash cylinder, tapered edges on the plastic wear pads located on the modular cart assembly may act as guides, facilitating centering of the cart in the channel as the cart is being pushed forward. Once the cart is inserted past the tapered edges, there is enough clearance between the flat edges of the wear pads and the channel to allow the cart assembly to be pushed forward without causing any substantial misalignment between the cart assembly and the wash cylinder. This ensures that the modular cart assembly is properly aligned with the wash cylinder before the wash cycle is initiated.

Although the technology has been described and illustrated with respect to exemplary embodiments thereof, it should be understood by those skilled in the art that the foregoing and various other changes, omissions and additions may be made therein and thereto, without parting from the spirit and scope of the present technology. It should also be understood that features described and illustrated in reference to one embodiment may be employed in other embodiments as appropriate.

What is claimed is:

1. A modular cart assembly, comprising:
a base with two support columns extending upward from the base;
a plurality of slots and a plurality of mounting openings positioned along the two support columns;
at least one removable part module comprising:
a plurality of hooks configured to removably mate with the plurality of slots, and
a plurality of mounting members configured to be removably received in the plurality of mounting openings;
wherein the at least one removable part module is configured to accommodate a plurality of items to be cleaned.

2. The modular cart assembly of claim 1, further comprising a bottom wheel portion configured to be moved on a surface, wherein the bottom wheel portion and the base portion are spaced apart.

3. The modular cart assembly of claim 2, wherein the bottom wheel portion comprises a locking mechanism configured to lock the modular cart assembly in place.

4. The modular cart assembly of claim 1, wherein each of the two support columns comprises two or more vertical rails, wherein each of the vertical rails accommodates at least one of the plurality of slots and the plurality of mounting holes.

5. The modular cart assembly of claim 1, wherein the two support columns further comprise one or more holding members configured to accommodate additional items to be cleaned.

6. The modular cart assembly of claim 1, wherein the at least one removable part module comprises a plurality of positioning elements configured to accommodate the plurality of items to be cleaned.

7. The modular cart assembly of claim 1, wherein the at least one removable part module comprises at least two side flanges extending perpendicular to a longitudinal axis of the removable part module.

8. The modular cart assembly of claim 7, wherein one end of each side flange supports one of the plurality of hooks and the opposite end of each side flange supports one of the plurality of mounting members.

9. The modular cart assembly of claim 1, wherein at least one of the plurality of mounting members comprises a securing device configured to removably secure the at least one removable part module in the modular cart assembly.

10. A modular cart assembly, comprising:
a base with a plurality of slots and a plurality of mounting openings;
at least one removable part module comprising a plurality of hooks configured to removably mate with the plurality of slots, and a plurality of mounting members configured to be removably received in the plurality of mounting openings; and
a bottom wheel portion configured to be moved on a surface, wherein the bottom wheel portion and the base portion are spaced apart;
wherein the at least one removable part module is configured to accommodate a plurality of items to be cleaned.

11. A washer system for cleaning items, comprising:
a wash chamber comprising a spray bar and a door; and
a modular cart assembly configured to accommodate a plurality of items to be cleaned, the modular cart assembly comprising:
a base with a plurality of slots and a plurality of mounting openings;
at least one removable part module comprising a plurality of hooks configured to removably mate with the plurality of slots, and a plurality of mounting members configured to be removably received in the plurality of mounting openings;
a bottom wheel portion configured to be moved on a surface, wherein the bottom wheel portion and the base portion are spaced apart;
wherein the modular cart assembly is configured to be inserted into the wash chamber through the door and is configured to remain in the wash chamber during a wash cycle.
